(19) United States
(12) Patent Application Publication
(10) Pub. No.: US 2007/0001439 A1
(43) Pub. Date: Jan. 4, 2007

(54) Gas generator for air bag

(75) Inventors: Naoki Matsuda, Tatsuno-Shi (JP); Mikio Yabuta, Tatsuno-Shi (JP); Kosuke Sakuma, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/453,101

(22) Filed: Jun. 15, 2006

Related U.S. Application Data
(60) Provisional application No. 60/692,570, filed on Jun. 22, 2005.

(30) Foreign Application Priority Data
Jun. 16, 2005 (JP) 2005-176343

(51) Int. Cl. B60R 21/26

(52) U.S. Cl. 280/741; 280/736

(57) ABSTRACT

The present invention relates to a gas generator for an air bag, comprising, in a housing having a gas discharge port, a combustion chamber, and the combustion chamber accommodating a gas generating agent that generates gas by combustion and an ignition device for igniting and combusting the gas generating agent, the ignition device being formed by integrating an electric igniter and a substantially cylindrical igniter collar with a resin in a state where the electric igniter is disposed inside the igniter collar, the ignition device being in contact with the bottom surface of the housing in at least part of the surface of the igniter collar and being attached on the housing bottom surface by at least one from the following attachment structures (1) to (3): (1) The igniter collar is fixed by a support member having a flat section and a tubular section extending upward from the flat section, the flat section is fixed to the housing bottom surface, and the upper end surface of the igniter collar is pressed and fixed by the open portion of the tubular section; (2) The igniter collar is fixed by caulking the lower end section thereof to the outer surface of the housing bottom surface; (3) Part of the surface of the igniter collar that is in contact with the housing bottom surface has an annular groove, and a fixing material is charged into the interior of the annular groove.

This nonprovisional application claims priority under 35 U.S.C. § 119(a) on Patent Application No. 2005-176343 filed in Japan on 16 Jun. 2005 and 35 U.S.C. § 119(e) on U.S. Provisional Application No. 60/692,570 filed on 22 Jun. 2005, which are incorporated by reference.

### BACKGROUND OF THE INVENTION

1. Field of the Invention

The present invention relates to a gas generator for an air bag used in a passenger restraining system in an automobile.

2. Description of the Related Art

In order to maintain good ignition ability of a gas generating agent, it is necessary to improve air tightness of a housing and prevent moisture from penetrating in the interior of a pyrotechnic type gas generator having a gas generating agent that generates gas by combustion. In particular, from the standpoint of structure and attachment operation it is important to ensure air tightness of an igniter attachment section of the housing.

JP-A No. 4-334641 discloses that a resin molded section is formed by injection or the like to fix a metal collar and an initiator. With this method both sides have to be welded to provide for air tightness when the metal collar is fixed below the housing. In this case, the size of the metal color has to be increased to ensure a heat sink function thereof during welding, so as to prevent the resin from deforming and losing tightness under the effect of welding heat.

U.S. Pat. No. 5,131,679 also discloses an ignition device of an pyrotechnic type gas generator.

### SUMMARY OF THE INVENITON

The present invention relates to a gas generator for an air bag, including, a housing having a gas discharge port, a combustion chamber, included in the housing, and a gas generating agent that generates gas by combustion and an ignition device for igniting and combusting the gas generating agent, accommodated in the combustion chamber accommodating,

the ignition device being formed by integrating an electric igniter and a substantially cylindrical igniter collar with a resin in a state where the electric igniter is disposed inside the igniter collar,

the ignition device being in contact with the bottom surface of the housing in at least part of the surface of the igniter collar and being attached on the housing bottom surface by at least one from the following attachment structures (1) to (3):

(1) The igniter collar is fixed by a support member having a flat section and a tubular section extending upward from the flat section, the flat section is fixed to the housing bottom surface, and the upper end surface of the igniter collar is pressed and fixed by the open portion of the tubular section;

(2) The igniter collar is fixed by caulking the lower end section thereof to the outer surface of the housing bottom surface;

(3) Part of the surface of the igniter collar that is in contact with the housing bottom surface has an annular groove, and a fixing material is charged into the interior of the annular groove.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows an axial sectional view of a gas generator for an air bag;

FIG. 2 shows a plan view of the gas generator shown in FIG. 1 (the ceiling portion has been removed);

FIG. 3 shows an explanatory drawing illustrating the attachment of the ignition device to the housing.

### DETAILED DESCRIPTION OF THE INVENTION

The present invention relates to a gas generator for an air bag that excels in maintaining air tightness in the attachment section of the housing and ignition device.

The attachment structure (1) increases air tightness of the contact surface of the igniter collar and housing bottom surface and air tightness of the contact surface of the igniter collar and support member (that is, air tightness of the housing interior) by pressing the igniter collar from above with the support member. The support member is fixed by welding to the housing bottom surface in the flat section. Because the welding may be conducted by spot welding in several places, the resin of the ignition device is hardly affected by heat during welding.

The attachment structure (2) increases air tightness of the housing interior by increasing the contact intimacy of the igniter collar and housing bottom surface (outer surface). Due to caulking, welding is unnecessary.

The attachment structure (3) increases air tightness of the housing interior by providing an annular groove in part of the surface of the igniter collar and charging a fixing material such as a resin or rubber into the annular groove (for example, by employing an injection molding method or a coating method).

Furthermore, an attachment structure (4) is also possible in which the tubular section of the support member is pressed from above by the resin that integrates the electric igniter and the igniter collar. The attachment structure (4) increases air tightness of the housing interior by increasing the contact intimacy of the support member and resin.

The gas generator for an air bag in accordance with the present invention can have only one from among the attachment structures (1), (2), and (3), a combination of two attachment structures, such as (1) and (2), (2) and (3), or (1) and (3), a combination of all the attachment structures (1) to (3), or optionally in combination with the attachment structure (4).

Because the gas generator for an air bag in accordance with the present invention has high air tightness in the attachment portion of the housing and ignition device and high resistance to humidity inside the housing, good ignition ability of the gas generating agent can be maintained over a long period.

### Embodiment of the Invention

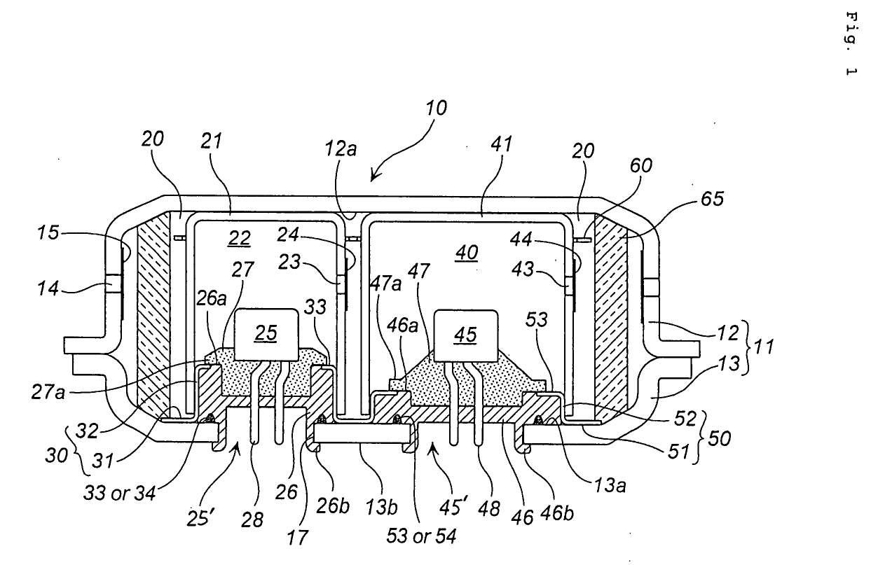

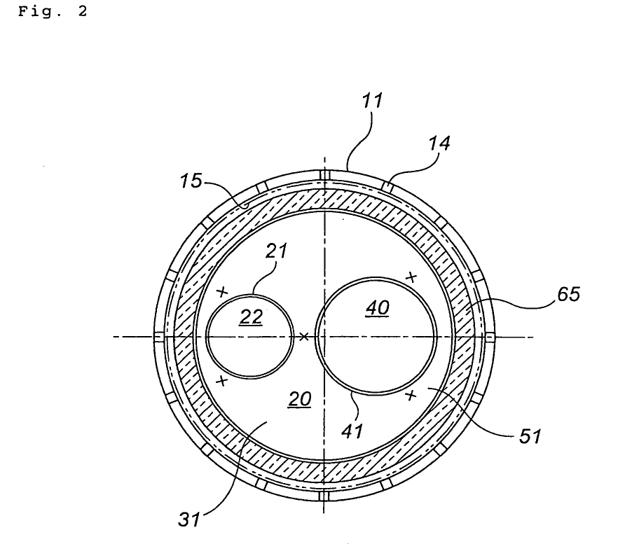

An embodiment of the invention will be described below with reference to FIG. 1 and FIG. 2. FIG. 1 is an axial sectional view of the gas generator for an air bag in accordance with the present invention. FIG. 2 is a schematic drawing illustrating the state where a closure shell was removed from the gas generator shown in FIG. 1. To facilitate understanding, the view of FIG. 1 is enlarged.

A gas generator 10 for an air bag shown in FIG. 1 and FIG. 2 is of a dual type which has two combustion chambers and two ignition devices, but the present invention is also applicable to a single-type gas generator having one combustion chamber and one ignition device. Furthermore, as an air bag inflation device, this gas generator is also suitable for a hybrid inflator using both a gas generating agent and a pressurized gas and an inflator (an inflator for a curtain) using only pressurized gas.

An outer shell of a gas generator 10 for an air bag is formed from a housing 11 in which a diffuser shell 12 and a closure shell 13 are joined integrally. The diffuser shell 12 and closure shell 13 are welded at a joint portion.

A plurality of gas discharge ports 14 are provided in the peripheral surface of the diffuser shell 12, and the gas discharge ports 14 are sealed from the inside by a sealing tape 15 made of aluminum or stainless steel to provide for resistance to humidity.

A first combustion chamber 20 and a second combustion chamber 40 are provided in the housing 11, and the second combustion chamber 40 is separated from the first combustion chamber 20 by a combustion chamber cup member 41.

A cup member 21 is disposed inside the first combustion chamber 20, and the internal space thereof serves as a first ignition device chamber 22. An enhancer agent (not shown in the figure) and a first ignition device 25′ are accommodated in the first ignition device chamber 22, and a first gas generating agent (not shown in the figure) is charged into the first combustion chamber 20.

A first through hole 23 is provided on the peripheral surface of the cup member 21 and sealed from the outside by a sealing tape 24 made of aluminum or stainless steel to hold the enhancer agent.

In the first ignition device 25′, a first electric igniter (first igniter) 25 is disposed inside a substantially cylindrical first igniter collar 26 made of a metal, and the first igniter 25 and the first igniter collar 26 are integrated by a resin 27. The reference numeral 28 stands for a conductive pin connected to a connector.

The first ignition device 25′ is attached to the housing bottom surface 13a by the following four attachment structures.

Attachment Structure (1)

A first support member 30 has a flat section 31 and a tubular section. 32 extending upward from the flat section 31. The distal end of the outer peripheral section of the flat section 31 is pressed from above and below by a coolant/filter 65 and the housing bottom surface 13a and fixed to the housing bottom surface 13a by spot welding in the locations marked by x symbols shown in FIG. 2. Here the outer peripheral section of the distal end of the flat section 31 and the coolant/filter 65 are tightly joined by crushing the end surface of the coolant/filter 65. The opening section of the tubular section 32 has an inward flange section 33. In the gas generator 10 for an air bag, there are a total of five locations marked by x symbols where spot welding was conducted because the first support member 30 and second support member 50 are formed integrally. The first support member 30 and the second support member 50 may be formed separately.

The first igniter collar 26 is surrounded on the periphery by the tubular section 32 of the first support member 30, and the outer surface of the first igniter collar 26 and the inner surface of the tubular section 32 are brought into intimate contact (the outer diameter of the first igniter collar 26 and the inner diameter of the tubular section 32 are substantially equal to each other). The upper end surface 26a of the first igniter collar 26 is pressed from above by the inward flange section 33.

The cup member 21 is positioned by fitting onto the tubular section 32, the bottom surface abuts against the housing ceiling surface 12a, and the opening portion of the cup member 21 may or may not be abutted against the flat surface 31.

By thus pressing the first igniter collar 26 from above with the first support member 30, air tightness of the contact surface of the first igniter collar 26 and the housing bottom surface 13a and the contact surface of the first igniter collar 26 and the first support member 30 (that is, air tightness in the interior of the housing 11) is increased. Furthermore, because, the first support member 30 may be spot welded to the housing bottom surface 13a only in several places on the flat section 31, the resin 27 is hardly affected by the heat during welding.

Attachment Structure (2)

The lower end surface of the first igniter collar 26 is fixed by caulking (caulking section 26b) to the outer bottom surface 13b of the housing 11. Therefore, no welding method is employed to fix the first igniter collar 26 to the housing bottom surface 13a, so that the resin 27 is not affected by the welding heat.

Attachment Structure (3)

A first annular groove 33 is provided on the surface where the first igniter collar 26 is in contact with the housing bottom surface 13a. The first annular groove 33 may be partially discontinuous. A fixing material 34 such as a resin or rubber is charged into the first annular groove 33. The fixing material 34 may be charged by an injection molding method or a coating method.

By inserting a combination of the first annular groove 33 and fixing material 34 between the first igniter collar 26 and the housing bottom surface 13a, air tightness of the interior of the housing 11 is increased.

Attachment Structure (4)

The attachment structure (4) relates to the attachment structure (1); here, the inward flange 33 of the first support member 30 is pressed from above by a radial protrusion 27a of the resin 27. By increasing the contact intimacy of the first support member 30 and resin 27 in such a manner, air tightness of the interior of the housing 11 is increased.

The second gas generating agent (not shown in the figure) and the second ignition device 45′ are accommodated inside the second combustion chamber 40. A second through hole 43 is provided in the peripheral surface of the combustion chamber cup member 41 and sealed from the outside with a sealing tape 44 made of aluminum or stainless steel in order to hold the second gas generating agent.

In the second ignition device 45′, a second electric igniter (second igniter) 45 is disposed inside a substantially cylindrical second igniter collar 46 made of a metal, and the second igniter 45 and the second igniter collar 46 are integrated by a resin 47. The reference numeral 48 stands for a conductive pin connected to a connector.

The second ignition device 45′ is attached to the housing bottom surface 13a by the following four attachment structures in the same manner as the first ignition device 25′.

Attachment Structure (1)

A second support member 50 has a flat section 51 and a tubular section 52 extending upward from the flat section 51. The distal end section of the flat section 51 is pressed from above and below by a coolant/filter 65 and the housing bottom surface 13a and fixed to the housing bottom surface 13a by spot welding in the locations marked by x symbols shown in FIG. 2. Here the distal end of the outer peripheral section of the flat section 51 and the coolant/filter 65 are tightly joined by crushing the end surface of the coolant/filter 65. The opening section of the tubular section 52 has an inward flange section 53. In the gas generator 10 for an air bag, there are a total of five locations marked by x symbols where spot welding was conducted because the second support member 50 and first support member 30 are integrated. The second support member 50 and the first support member 30 may be formed separately.

The combustion chamber cup member 41 is positioned by fitting onto the tubular section 52, the bottom surface abuts against the housing ceiling surface 12a, and the opening portion of the cup member may or may not be abutted against the flat surface 51.

By thus pressing the second igniter collar 46 from above with the second support member 50, air tightness of the contact surface of the second igniter collar 46 and the housing bottom surface 13a and the contact surface of the second igniter collar 46 and the second support member 50 (that is, air tightness in the interior of the housing 11) is increased. Furthermore, because, the second support member 50 may be spot welded to the housing bottom surface 13a only in several places on the flat section 51, the resin 47 is hardly affected by the heat during welding.

Attachment Structure (2)

The lower end surface of the second igniter collar 46 is fixed by caulking (caulking section 46b) to the outer surface 13b of the housing 11. Therefore, no welding method is employed to fix the second igniter collar 46 to the housing bottom surface 13a, so that the resin 47 is not affected by the welding heat.

Attachment Structure (3)

A second annular groove 53 is provided on the surface where the second igniter collar 46 is in contact with the housing bottom surface 13a. The second annular groove 53 may be partially discontinuous. A fixing material 54 such as a resin or rubber is charged into the second annular groove 53. The fixing material 54 may be charged by an injection molding method or a coating method.

By inserting a combination of the second annular groove 53 and the fixing material 54 between the second igniter collar 46 and the housing bottom surface 13a, air tightness of the interior of the housing 11 is increased.

Attachment Structure (4)

The attachment structure (4) relates to the attachment structure (1); here, the inward flange 53 of the second support member 50 is pressed from above by a radial protrusion 47a of the resin 47. By increasing the contact intimacy of the second support member 50 and resin 47 in such a manner, air tightness of the interior of the housing 11 is increased.

Other Attachment Structures

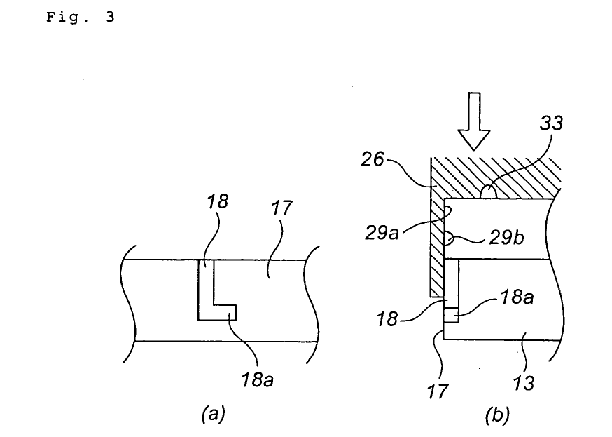

Other attachment structures will be explained below with reference to FIGS. 3(a), (b). In the bottom surface 13a of the closure shell 13, two holes are provided for inserting the first ignition device 25′ and the second ignition device 45′ therein and for connecting the conductive pins 28, 48 to the connector (not shown in the drawing).

At least a single L-shaped groove 18 is provided on the annular surface 17 of the hole for fitting the first ignition device 25′. On the other hand, a protrusion 29b is provided on the surface 29a of the first igniter collar 26 which abuts against the annular surface 17.

In FIG. 3(b), when the first igniter collar 26 is fitted from the top down (direction shown by an arrow), the protrusion 29b is inserted so as to be fitted into the L-shaped groove 18, and the first igniter collar 26 is slightly turned to position the protrusion 29b at the distal end section 18a of the groove 18. The first igniter collar 26 is thereby prevented from rotating, and subsequent caulking operation is facilitated.

The projection height of the protrusion 29b is equal to or less than the depth of the L-shaped groove, and the forming position of the protrusion 29b is adjusted so that the caulking operation can be conducted when the protrusion 29b is positioned in the distal end section 18a. A similar attachment structure can be also employed in the second ignition device 45′.

A disk-like retainer 60 for adjusting the volume of the first combustion chamber 20 in accordance with the charged amount of the first gas generating agent is fitted into the first combustion chamber 20. The retainer 60 has two holes and those two holes are fitted onto the cup member 21 and combustion chamber cup member 41.

A cylindrical coolant/filter 65, which has functions of filtering and cooling combustion gas, is disposed on the outside of the first combustion chamber 20, and a gap is provided between the outer peripheral surface of the coolant/filter 65 and the gas discharge port 14 and sealing tape 15.

In the gas generator 10 for an air bag, because the joint of the diffuser shell 12 and the closure shell 13 is welded, no moisture permeates, and because the gas discharge port 14 is sealed from the inside with the sealing tape, mo moisture permeates. Furthermore, as described hereinabove, the attachment section of the ignition device (the first ignition device 25′ and the second ignition device 45′) and the housing 11, which has a complex attachment structure and a high probability of moisture permeation is provided with high air tightness by the combinations of the attachment structures (1) to (3), or optionally attachment structures (1) to (4).

Therefore, in a case where the gas generator for an air bag of the present invention is incorporated in a passenger restraining system in an automobile, the interior of the housing 11 can maintain high resistance to humidity for not less than 10 years which is the lifetime of an automobile.

The operation of the gas generator 10 for an air bag shown in FIG. 1 when applied to an air bag system of an automobile will be described below. The case where the first igniter 25 is activated first and the second igniter 45 is activated with a delay will be described below.

When the automobile receives an impact upon collision, an activation signal is received from a control unit, whereby the first igniter 25 is activated and ignited, causing ignition and combustion of the enhancer agent. The pressure rises thereafter inside the ignition device chamber 22, whereby the sealing tape 24, which seals the first through hole 23, is fractured and the combustion product (ignition energy) is discharged through the first through hole 23 into the first combustion chamber 20.

The discharge of the combustion product causes ignition and combustion of the first gas generating agent and high-temperature combustion gas is generated. The combustion gas is filtered and cooled as it passes through the coolant/filter 65, whereupon the combustion gas ruptures the sealing tape 15 and is discharged through the gas discharge port 14 to inflate the air bag.

The second igniter 45 is activated and ignited with a slight delay, whereby the second gas generating agent is ignited and combusted and high-temperature combustion gas is generated. Under the pressure applied by the high-temperature combustion gas, the sealing tape 44 that seals the second through hole 43 is fractured, thereby releasing the flow of the combustion gas through the second through hole 43. The combustion gas is filtered and cooled as it passes through the coolant/filter 65 and then discharged through the gas discharge port 14 to inflate further the air bag.

The invention thus described, it will be obvious that the same may be varied in many ways. Such variations are not to be regarded as a departure from the spirit and scope of the invention, and all such modifications as would be obvious to one skilled in the art are intended to be included within the scope of the following claim.

1. A gas generator for an air bag, comprising, a housing having a gas discharge port, a combustion chamber, included in the housing, and a gas generating agent that generates gas by combustion and an ignition device for igniting and combusting the gas generating agent, accommodated in the combustion chamber,
the ignition device being formed by integrating an electric igniter and a substantially cylindrical igniter collar with a resin in a state where the electric igniter is disposed inside the igniter collar,
the ignition device being in contact with the bottom surface of the housing in at least part of the surface of the igniter collar and being attached on the housing bottom surface by at least one from the following attachment structures (1) to (3)
(1) The igniter collar is fixed by a support member having a flat section and a tubular section extending upward from the flat section, the flat section is fixed to the housing bottom surface, and the upper end surface of the igniter collar is pressed and fixed by the open portion of the tubular section;
(2) The igniter collar is fixed by caulking the lower end section thereof to the outer surface of the housing bottom surface;
(3) Part of the surface of the igniter collar that is in contact with the housing bottom surface has an annular groove, and a fixing material is charged into the interior of the annular groove.
